(19) United States
(12) Patent Application Publication
(10) Pub. No.: US 2020/0363800 A1
(43) Pub. Date: Nov. 19, 2020

(54) Decision Making Methods and Systems for Automated Vehicle

(71) Applicant: Great Wall Motor Company Limited, Baoding (CN)

(72) Inventors: Munir Jojo-Verge, Novi, MI (US); Alexander Stimpson, West Bloomfield, MI (US)

(73) Assignee: Great Wall Motor Company Limited, Baoding (CN)

(21) Appl. No.: 16/410,261

(22) Filed: May 13, 2019

(51) Int. Cl. G05D 1/00; G05D 1/02

(52) U.S. Cl. CPC G05D 1/0088; G05D 1/0212

(57) ABSTRACT

Methods and systems for decision making in an autonomous vehicle (AV) are described. A probabilistic explorer reduces the breadth and depth of the potentially infinite actions being explored allowing for an accurate prediction on a future scene to a defined time horizon and an appropriate selection of a goal state anywhere within that time horizon. The probabilistic explorer uses a neural network (NN) to suggest best (probabilistically speaking) actions for the AV and scene values, and a modified Monte Carlo Tree Search to identify a sequence of actions, where exploration is guided by the NN. The probabilistic explorer processes the suggested actions and driving scene(s) to provide estimated trajectories of all scene actors and an estimated trajectory for the AV at every time step for every action explored. A virtual driving scene is generated, which is iteratively processed to determine a vehicle goal state or vehicle low-level control actions.

### TECHNICAL FIELD

This disclosure relates to autonomous vehicles. More specifically, this disclosure relates to behavior planning and decision making methods for autonomous vehicles.

### BACKGROUND

Autonomous vehicles (AV)s need to make decisions in dynamic, uncertain environments with tight coupling between the actions of all other actors involved in a driving scene, i.e. perform behavioral planning. A behavioral planning layer may be configured to determine a driving behavior based on perceived behavior of other actors, road conditions, and infrastructure signals. Much progress towards solving this problem has been made using Artificial Intelligent (A.I.) systems that are trained to replicate the decisions of human experts. However, expert data is often expensive, unreliable, or simply unavailable. Even when reliable data is available it may impose a ceiling on the performance of systems trained in this manner since humans make mistakes and have limitations that sometimes get propagated to the A.I. systems.

### SUMMARY

Disclosed herein are implementations of behavior planning and decision-making methods and systems. The behavior planning component may be configured to propose a vehicle goal state in a specific time step as a tactical-level decision towards a high-level strategic goal destination. The behavior planning component may use a probabilistic exploration unit, an action and scene value estimator, an Interactive Intent Prediction (IIP) unit, short-term and long-term cost and value functions, and an advanced vehicle motion model. The action and scene value estimator may use a current driving scene and driving scene history to determine driving actions and estimated scene value and costs. The probabilistic exploration unit, the IIP, and the advanced vehicle motion model may use the driving actions, estimated scene value, and cost to determine estimated trajectories for the AV and other actors in the driving scene. The action and scene value estimator, probabilistic exploration unit, IIP, and advanced vehicle motion model iterate through explored actions, scenes, costs and values to eventually output a vehicle goal state to a motion planner or vehicle control actions to a controller, depending on temporal proximity of the goal horizon or on whether the behavior planner may run at the same or even higher frequency than the vehicle controllers. The motion planner may compute a trajectory that is safe and comfortable for the controller to execute based in part on the vehicle goal state.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of a vehicle in accordance with embodiments of this disclosure.

FIG. 2 is a diagram of an example of the control system shown in FIG. 1.

FIG. 3 is a diagram of an example of a vehicle control system in accordance with embodiments of this disclosure.

FIG. 4 is a diagram of an example of a side view of a vehicle including a vehicle control system in accordance with embodiments of this disclosure.

FIG. 5 is a diagram of an example of a vehicle control system in accordance with embodiments of this disclosure.

FIG. 6 is a diagram of an example of a vehicle control system in accordance with embodiments of this disclosure.

FIG. 7 is a diagram of an example of an autonomous vehicle behavior planning flow in accordance with embodiments of this disclosure.

FIG. 8A and FIG. 8B are diagrams of an example of a scene with regions of interest and state information in accordance with embodiments of this disclosure.

FIG. 9 is a diagram of an example of state information in accordance with embodiments of this disclosure.

FIG. 10 is a diagram of an example of state information in accordance with embodiments of this disclosure.

FIG. 11 is a diagram of an example of a combined policy and value network in accordance with embodiments of this disclosure.

FIG. 12A and FIG. 12B are diagrams of an example neural network and a residual network in accordance with embodiments of this disclosure.

FIG. 13 is a diagram of an example of probabilistic exploration method in accordance with embodiments of this disclosure.

FIG. 14A, FIG. 14B and FIG. 14C are diagrams of an exhaustive search, policy-based reduction search and value-based reduction search in accordance with embodiments of this disclosure.

FIG. 15 is a diagram of an example of a simulated drive for MCTS training in accordance with embodiments of this disclosure.

FIG. 16 is a diagram of an example of neural network training in accordance with embodiments of this disclosure.

FIG. 17 is a diagram of an example of a method for decision making in accordance with embodiments of this disclosure.

### DETAILED DESCRIPTION

Reference will now be made in greater detail to embodiments of the invention, an example of which is illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices and methods shown and described herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Autonomous vehicles (AV)s are a maturing technology with the potential to reshape mobility by enhancing the safety, accessibility, efficiency, and convenience of automotive transportation. Safety-critical tasks that may be executed by an AV include behavior and motion planning through a dynamic environment shared with other vehicles and pedestrians, and their robust executions via feedback control. A long-standing goal of AVs is to solve the problem of decision-making in dynamic, uncertain environments with tight coupling between the actions of all other actors involved in a driving scene, i.e. behavioral planning. The behavioral planning layer may be configured to determine a driving behavior based on perceived behavior of other actors, road conditions, and infrastructure signals. Much progress towards solving this problem has been made using Artificial Intelligent (A.I.) systems that are trained to replicate the decisions of human experts. However, expert data is often expensive, unreliable, or simply unavailable. Even when reliable data is available it may impose a ceiling on the performance of systems trained in this manner since humans make mistakes and have limitations that sometimes get propagated to the A.I. systems. Moreover, estimation of a vehicle's best goal state (at a defined time horizon) using a brute force exploration of all sequences of actions (potentially infinite) until this horizon is reached is an intractable problem.

To address the above issues, the embodiments disclosed herein may apply reinforcement learning (RL) systems and techniques to behavior planning. RL systems and techniques are trained from their own experience, in principle allowing them to exceed human capabilities, and to operate in domains where human expertise is lacking. The RL technique described herein is combined with and implemented via a probabilistic exploration unit, an action and scene value estimator, an Interactive Intent Prediction (IIP) unit, short-term and long-term cost and value functions, and an advanced vehicle motion model, to propose a vehicle goal state in a specific time step as a tactical-level decision towards a high-level strategic goal destination. The action and scene value estimator may use a current driving scene and driving scene history to determine driving actions and estimated scene value and costs. The probabilistic exploration unit, the IIP, and the advanced vehicle motion model may use the driving actions, estimated scene value and costs to determine estimated trajectories for the AV and other actors in the driving scene. The action and scene value estimator, probabilistic exploration unit, IIP, and advanced vehicle motion model iterate through explored actions, scenes, costs and values to eventually output a vehicle goal state to a motion planner or vehicle control actions to a controller, depending on temporal proximity of the goal horizon or on whether the behavior planner may run at the same or even higher frequency than the vehicle controllers. The motion planner may compute a trajectory that is safe and comfortable for the controller to execute based in part on the vehicle goal state.

The combination of the above elements, collectively a probabilistic explorer, reduce the breadth and depth of the potentially infinite actions being explored allowing for an accurate prediction on the future scene to a defined time horizon and consequently to an appropriate selection of a goal state anywhere within that time horizon. The action and scene value estimator may be viewed as an expert guiding module that uses a neural network to suggest the “best” (probabilistically speaking) actions for the autonomous vehicle to take and provide a scene value. The probabilistic exploration unit may use a modified Monte Carlo Tree Search to identify a sequence of actions that are likely to produce successful outcomes. The suggested actions and driving scene(s) are processed by the IIP module to provide estimated trajectories of all other scene actors at every time step for every action explored and the suggested actions are processed by the advanced vehicle motion model to provide an estimated trajectory for the AV for every action explored. These outputs may then be used to generate a virtual driving scene which is fed back to the probabilistic exploration unit, which runs the action and scene value estimator to generate actions and a value based on the virtual scene state. The probabilistic explorer iterates through this process to determine a vehicle goal state or vehicle low-level control actions.

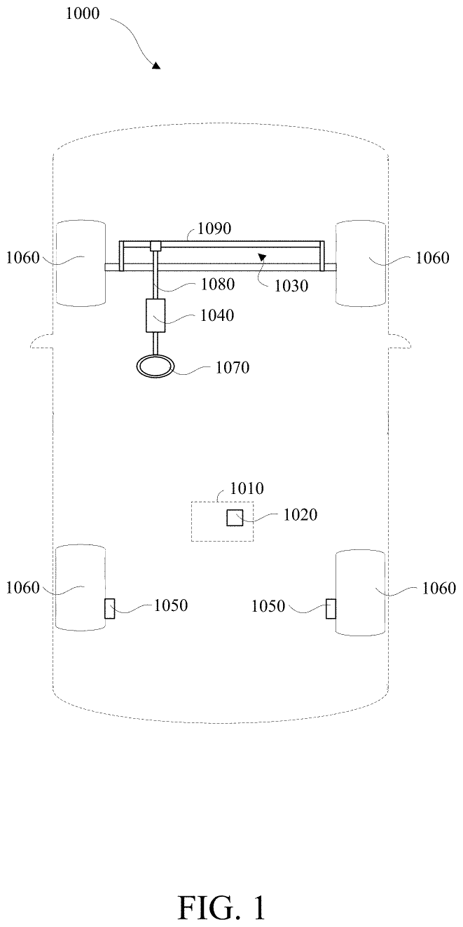

FIG. 1 is a diagram of an example of a vehicle 1000 in accordance with embodiments of this disclosure. The vehicle 1000 may be an autonomous vehicle (AV) or a semi-autonomous vehicle. As shown in FIG. 1, the vehicle 1000 includes a control system 1010. The control system 1010 may be referred to as a controller. The control system 1010 includes a processor 1020. The processor 1020 is programmed to command application of one of up to a predetermined steering torque value and up to a predetermined net asymmetric braking force value. Each predetermined force is selected to achieve a predetermined vehicle yaw torque that is at most the lesser of a first maximum yaw torque resulting from actuating a steering system 1030 and a second maximum yaw torque resulting from actuating a brake system.

The steering system 1030 may include a steering actuator 1040 that is an electric power-assisted steering actuator. The brake system may include one or more brakes 1050 coupled to respective wheels 1060 of the vehicle 1000. Additionally, the processor 1020 may be programmed to command the brake system to apply a net asymmetric braking force by each brakes 1050 applying a different braking force than the other brakes 1050.

The processor 1020 may be further programmed to command the brake system to apply a braking force, for example a net asymmetric braking force, in response to a failure of the steering system 1030. Additionally or alternatively, the processor 1020 may be programmed to provide a warning to an occupant in response to the failure of the steering system 1030. The steering system 1030 may be a power-steering control module. The control system 1010 may include the steering system 1030. Additionally, the control system 1010 may include the brake system.

The steering system 1030 may include a steering actuator 1040 that is an electric power-assisted steering actuator. The brake system may include two brakes 1050 coupled to respective wheels 1060 on opposite sides of the vehicle 1000. Additionally, the method may include commanding the brake system to apply a net asymmetric braking force by each brakes 1050 applying a different braking force.

The control system 1010 allows one of the steering system 1030 and the brake system to take over for the other of the steering system 1030 and the brake system if the other fails while the vehicle 1000 is executing a turn. Whichever of the steering system 1030 and the braking system remains operable is then able to apply sufficient yaw torque to the vehicle 1000 to continue the turn. The vehicle 1000 is therefore less likely to impact an object such as another vehicle or a roadway barrier, and any occupants of the vehicle 1000 are less likely to be injured.

The vehicle 1000 may operate in one or more of the levels of autonomous vehicle operation. For purposes of this disclosure, an autonomous mode is defined as one in which each of propulsion (e.g., via a powertrain including an electric motor and/or an internal combustion engine), braking, and steering of the vehicle 1000 are controlled by the processor 1020; in a semi-autonomous mode the processor 1020 controls one or two of the propulsion, braking, and steering of the vehicle 1000. Thus, in one example, non-autonomous modes of operation may refer to SAE levels 0-1, partially autonomous or semi-autonomous modes of operation may refer to SAE levels 2-3, and fully autonomous modes of operation may refer to SAE levels 4-5.

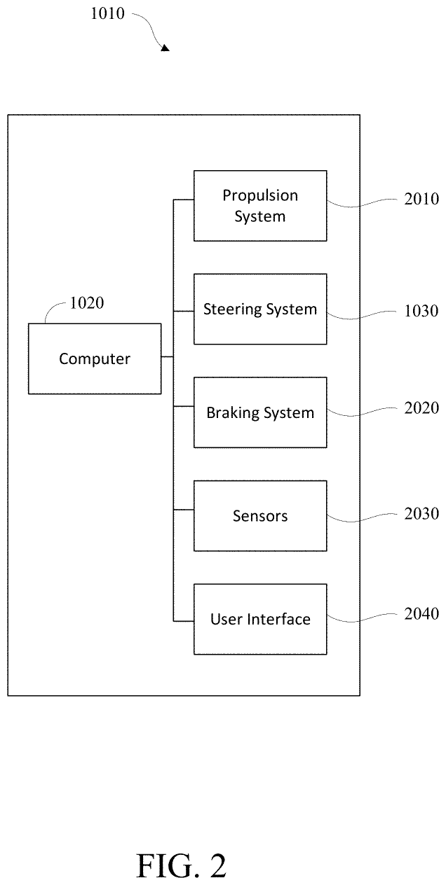

With reference to FIG. 2, the control system 1010 includes the processor 1020. The processor 1020 is included in the vehicle 1000 for carrying out various operations, including as described herein. The processor 1020 is a computing device that generally includes a processor and a memory, the memory including one or more forms of computer-readable media, and storing instructions executable by the processor for performing various operations, including as disclosed herein. The memory of the processor 1020 further generally stores remote data received via various communications mechanisms; e.g., the processor 1020 is generally configured for communications on a communications network within the vehicle 1000. The processor 1020 may also have a connection to an onboard diagnostics connector (OBD-II). Although one processor 1020 is shown in FIG. 2 for ease of illustration, it is to be understood that the processor 1020 could include, and various operations described herein could be carried out by, one or more computing devices. The processor 1020 may be a control module, for example, a power-steering control module, or may include a control module among other computing devices.

The control system 1010 may transmit signals through the communications network, which may be a controller area network (CAN) bus, Ethernet, Local Interconnect Network (LIN), Bluetooth, and/or by any other wired or wireless communications network. The processor 1020 may be in communication with a propulsion system 2010, the steering system 1030, the brake system 2020, sensors 2030, and/or a user interface 2040, among other components.

With continued reference to FIG. 2, the propulsion system 2010 of the vehicle 1000 generates energy and translates the energy into motion of the vehicle 1000. The propulsion system 2010 may be a known vehicle propulsion subsystem, for example, a conventional powertrain including an internal-combustion engine coupled to a transmission that transfers rotational motion to road wheels 1060; an electric powertrain including batteries, an electric motor, and a transmission that transfers rotational motion to the road wheels 1060; a hybrid powertrain including elements of the conventional powertrain and the electric powertrain; or any other type of propulsion. The propulsion system 2010 is in communication with and receives input from the processor 1020 and from a human driver. The human driver may control the propulsion system 2010 via, e.g., an accelerator pedal and/or a gear-shift lever (not shown).

With reference to FIGS. 1 and 2, the steering system 1030 is typically a known vehicle steering subsystem and controls the turning of the road wheels 1060. The steering system 1030 is in communication with and receives input from a steering wheel 1070 and the processor 1020. The steering system 1030 may be a rack-and-pinion system with electric power-assisted steering via a steering actuator 1040, a steer-by-wire system, as are both known in the art, or any other suitable system. The steering system 1030 may include the steering wheel 1070 fixed to a steering column 1080 coupled to a steering rack 1090.

With reference to FIG. 1, the steering rack 1090 is turnably coupled to the road wheels 1060, for example, in a four-bar linkage. Translational motion of the steering rack 1090 results in turning of the road wheels 1060. The steering column 1080 may be coupled to the steering rack 1090 via a rack-and-pinion, that is, gear meshing between a pinion gear and a rack gear (not shown).

The steering column 1080 transfers rotation of the steering wheel 1070 to movement of the steering rack 1090. The steering column 1080 may be, e.g., a shaft connecting the steering wheel 1070 to the steering rack 1090. The steering column 1080 may house a torsion sensor and a clutch (not shown).

The steering wheel 1070 allows an operator to steer the vehicle 1000 by transmitting rotation of the steering wheel 1070 to movement of the steering rack 1090. The steering wheel 1070 may be, e.g., a rigid ring fixedly attached to the steering column 1080 such as is known.

With continued reference to FIG. 1, the steering actuator 1040 is coupled to the steering system 1030, e.g., the steering column 1080, so as to cause turning of the road wheels 1060. For example, the steering actuator 1040 may be an electric motor rotatably coupled to the steering column 1080, that is, coupled so as to be able to apply a steering torque to the steering column 1080. The steering actuator 1040 may be in communication with the processor 1020.

The steering actuator 1040 may provide power assist to the steering system 1030. In other words, the steering actuator 1040 may provide torque in a direction in which the steering wheel 1070 is being rotated by a human driver, allowing the driver to turn the steering wheel 1070 with less effort. The steering actuator 1040 may be an electric power-assisted steering actuator.

With reference to FIGS. 1 and 2, the brake system 2020 is typically a known vehicle braking subsystem and resists the motion of the vehicle 1000 to thereby slow and/or stop the vehicle 1000. The brake system 2020 includes brakes 1050 coupled to the road wheels 1060. The brakes 1050 may be friction brakes such as disc brakes, drum brakes, band brakes, and so on; regenerative brakes; any other suitable type of brakes; or a combination. The brakes 1050 may be coupled to, e.g., respective road wheels 1060 on opposite sides of the vehicle 1000. The brake system 2020 is in communication with and receives input from the processor 1020 and a human driver. The human driver may control the braking via, e.g., a brake pedal (not shown).

With reference to FIG. 2, the vehicle 1000 may include the sensors 2030. The sensors 2030 may detect internal states of the vehicle 1000, for example, wheel speed, wheel orientation, and engine and transmission variables. The sensors 2030 may detect the position or orientation of the vehicle 1000, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 2030 may detect the external world, for example, radar sensors, scanning laser range finders, light detection and ranging (LIDAR) devices, and image processing sensors such as cameras. The sensors 2030 may include communications devices, for example, vehicle-to-infrastructure (V2I) devices, vehicle-to-vehicle (V2V) devices, or vehicle-to-everything (V2V) devices.

The user interface 2040 presents information to and receives information from an occupant of the vehicle 1000. The user interface 2040 may be located, e.g., on an instrument panel in a passenger cabin (not shown) of the vehicle 1000, or wherever may be readily seen by the occupant. The user interface 2040 may include dials, digital readouts, screens, speakers, and so on for output, i.e., providing information to the occupant, e.g., a human-machine interface (HMI) including elements such as are known. The user interface 2040 may include buttons, knobs, keypads, touchscreens, microphones, and so on for receiving input, i.e., information, instructions, etc., from the occupant.

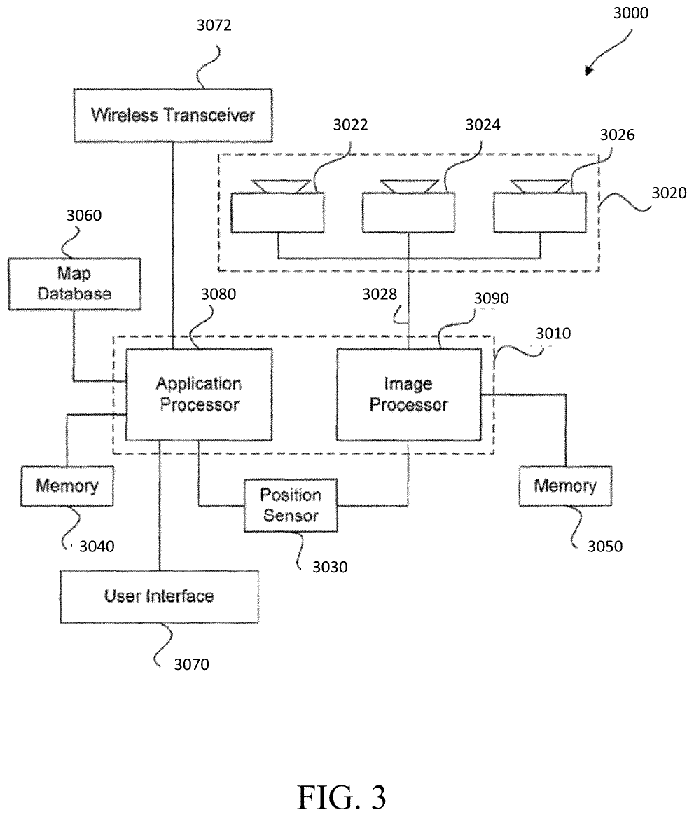

FIG. 3 is a diagram of an example of a vehicle control system 3000 in accordance with embodiments of this disclosure. Vehicle control system 3000 may include various components depending on the requirements of a particular implementation. In some embodiments, vehicle control system 3000 may include a processing unit 3010, an image acquisition unit 3020, a position sensor 3030, one or more memory units 3040, 3050, a map database 3060, a user interface 3070, and a wireless transceiver 3072. Processing unit 3010 may include one or more processing devices. In some embodiments, processing unit 3010 may include an applications processor 3080, an image processor 3090, or any other suitable processing device. Similarly, image acquisition unit 3020 may include any number of image acquisition devices and components depending on the requirements of a particular application. In some embodiments, image acquisition unit 3020 may include one or more image capture devices (e.g., cameras, CCDs, or any other type of image sensor), such as image capture device 3022, image capture device 3024, and image capture device 3026. System 3000 may also include a data interface 3028 communicatively connecting processing unit 3010 to image acquisition unit 3020. For example, data interface 3028 may include any wired and/or wireless link or links for transmitting image data acquired by image acquisition unit 3020 to processing unit 3010.

Wireless transceiver 3072 may include one or more devices configured to exchange transmissions over an air interface to one or more networks (e.g., cellular, the Internet, etc.) by use of a radio frequency, infrared frequency, magnetic field, or an electric field. Wireless transceiver 3072 may use any known standard to transmit and/or receive data (e.g., Wi-Fi, Bluetooth®, Bluetooth Smart, 802.15.4, ZigBee, etc.). Such transmissions may include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 3080 and image processor 3090 may include various types of hardware-based processing devices. For example, either or both of applications processor 3080 and image processor 3090 may include a microprocessor, preprocessors (such as an image preprocessor), graphics processors, a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, or the like.

In some embodiments, applications processor 3080 and/or image processor 3090 may include multiple processing units with local memory and instruction sets. Such processors may include video inputs for receiving image data from multiple image sensors and may also include video out capabilities. In one example, the processor may use 90 nm-micron technology operating at 332 Mhz.

Any of the processing devices disclosed herein may be configured to perform certain functions. Configuring a processing device, such as any of the described processors, other controllers or microprocessors, to perform certain functions may include programming of computer executable instructions and making those instructions available to the processing device for execution during operation of the processing device. In some embodiments, configuring a processing device may include programming the processing device directly with architectural instructions. In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 3 depicts two separate processing devices included in processing unit 3010, more or fewer processing devices may be used. For example, in some embodiments, a single processing device may be used to accomplish the tasks of applications processor 3080 and image processor 3090. In other embodiments, these tasks may be performed by more than two processing devices. Further, in some embodiments, vehicle control system 3000 may include one or more of processing unit 3010 without including other components, such as image acquisition unit 3020.

Processing unit 3010 may comprise various types of devices. For example, processing unit 3010 may include various devices, such as a controller, an image preprocessor, a central processing unit (CPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 3010. In another instance, the memory may be integrated into the processing unit 3010.

Each memory 3040, 3050 may include software instructions that when executed by a processor (e.g., applications processor 3080 and/or image processor 3090), may control operation of various aspects of vehicle control system 3000. These memory units may include various databases and image processing software, as well as a trained system, such as a neural network, or a deep neural network, for example. The memory units may include random access memory, read only memory, flash memory, disk drives, optical storage, tape storage, removable storage and/or any other types of storage. In some embodiments, memory units 3040, 3050 may be separate from the applications processor 3080 and/or image processor 3090. In other embodiments, these memory units may be integrated into applications processor 3080 and/or image processor 3090.

Position sensor 3030 may include any type of device suitable for determining a location associated with at least one component of vehicle control system 3000. In some embodiments, position sensor 3030 may include a GPS receiver. Such receivers can determine a user position and velocity by processing signals broadcasted by global positioning system satellites. Position information from position sensor 3030 may be made available to applications processor 3080 and/or image processor 3090.

In some embodiments, vehicle control system 3000 may include components such as a speed sensor (e.g., a speedometer) for measuring a speed of vehicle 1000. Vehicle control system 3000 may also include one or more accelerometers (either single axis or multi-axis) for measuring accelerations of vehicle 1000 along one or more axes.

The memory units 3040, 3050 may include a database, or data organized in any other form, that indication a location of known landmarks. Sensory information (such as images, radar signal, depth information from lidar or stereo processing of two or more images) of the environment may be processed together with position information, such as a GPS coordinate, vehicle's ego motion, etc. to determine a current location of the vehicle relative to the known landmarks, and refine the vehicle location.

User interface 3070 may include any device suitable for providing information to or for receiving inputs from one or more users of vehicle control system 3000. In some embodiments, user interface 3070 may include user input devices, including, for example, a touchscreen, microphone, keyboard, pointer devices, track wheels, cameras, knobs, buttons, or the like. With such input devices, a user may be able to provide information inputs or commands to vehicle control system 3000 by typing instructions or information, providing voice commands, selecting menu options on a screen using buttons, pointers, or eye-tracking capabilities, or through any other suitable techniques for communicating information to vehicle control system 3000.

User interface 3070 may be equipped with one or more processing devices configured to provide and receive information to or from a user and process that information for use by, for example, applications processor 3080. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 3070 may include a display, speaker, tactile device, and/or any other devices for providing output information to a user.

Map database 3060 may include any type of database for storing map data useful to vehicle control system 3000. In some embodiments, map database 3060 may include data relating to the position, in a reference coordinate system, of various items, including roads, water features, geographic features, businesses, points of interest, restaurants, gas stations, etc. Map database 3060 may store not only the locations of such items, but also descriptors relating to those items, including, for example, names associated with any of the stored features. In some embodiments, map database 3060 may be physically located with other components of vehicle control system 3000. Alternatively or additionally, map database 3060 or a portion thereof may be located remotely with respect to other components of vehicle control system 3000 (e.g., processing unit 3010). In such embodiments, information from map database 3060 may be downloaded over a wired or wireless data connection to a network (e.g., over a cellular network and/or the Internet, etc.). In some cases, map database 3060 may store a sparse data model including polynomial representations of certain road features (e.g., lane markings) or target trajectories for the host vehicle. Map database 3060 may also include stored representations of various recognized landmarks that may be used to determine or update a known position of the host vehicle with respect to a target trajectory. The landmark representations may include data fields such as landmark type, landmark location, among other potential identifiers.

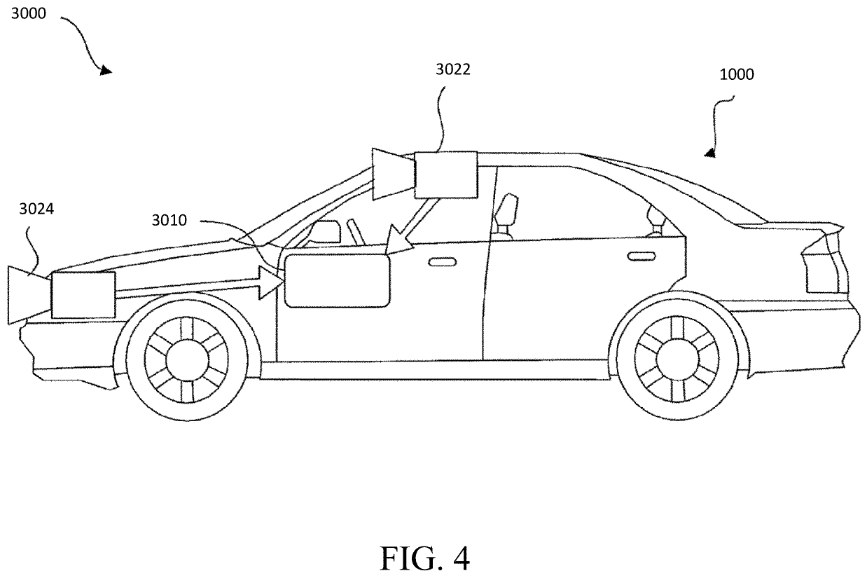

Image capture devices 3022, 3024, and 3026 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 3022, 3024, and 3026 will be further described with reference to FIG. 4 below.

One or more cameras (e.g., image capture devices 3022, 3024, and 3026) may be part of a sensing block included on a vehicle. Various other sensors may be included in the sensing block, and any or all of the sensors may be relied upon to develop a sensed navigational state of the vehicle. In addition to cameras (forward, sideward, rearward, etc.), other sensors such as RADAR, LIDAR, and acoustic sensors may be included in the sensing block. Additionally, the sensing block may include one or more components configured to communicate and transmit/receive information relating to the environment of the vehicle. For example, such components may include wireless transceivers (RF, etc.) that may receive from a source remotely located with respect to the host vehicle sensor based information or any other type of information relating to the environment of the host vehicle. Such information may include sensor output information, or related information, received from vehicle systems other than the host vehicle. In some embodiments, such information may include information received from a remote computing device, a centralized server, etc. Furthermore, the cameras may take on many different configurations: single camera units, multiple cameras, camera clusters, long FOV, short FOV, wide angle, fisheye, or the like.

FIG. 4 is a diagram of an example of a side view of vehicle 1000 including a vehicle control system 3000 in accordance with embodiments of this disclosure. For example, vehicle 1000 may be equipped with a processing unit 3010 and any of the other components of vehicle control system 3000, as described above relative to FIG. 3. While in some embodiments vehicle 1000 may be equipped with only a single image capture device (e.g., camera), in other embodiments, multiple image capture devices may be used. For example, either of image capture devices 3022 and 3024 of vehicle 1000, as shown in FIG. 4, may be part of an Advanced Driver Assistance Systems (ADAS) imaging set.

The image capture devices included on vehicle 1000 as part of the image acquisition unit 3020 may be positioned at any suitable location. In some embodiments, image capture device 3022 may be located in the vicinity of the rearview mirror. This position may provide a line of sight similar to that of the driver of vehicle 1000, which may aid in determining what is and is not visible to the driver. Image capture device 3022 may be positioned at any location near the rearview mirror, but placing image capture device 3022 on the driver side of the mirror may further aid in obtaining images representative of the driver's field of view and/or line of sight.

Other locations for the image capture devices of image acquisition unit 3020 may also be used. For example, image capture device 3024 may be located on or in a bumper of vehicle 1000. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 3022, 3024, and 3026) may also be located in other locations. For example, the image capture devices may be located on or in one or both of the side mirrors of vehicle 1000, on the roof of vehicle 1000, on the hood of vehicle 1000, on the trunk of vehicle 1000, on the sides of vehicle 1000, mounted on, positioned behind, or positioned in front of any of the windows of vehicle 1000, and mounted in or near light fixtures on the front and/or back of vehicle 1000.

In addition to image capture devices, vehicle 1000 may include various other components of vehicle control system 3000. For example, processing unit 3010 may be included on vehicle 1000 either integrated with or separate from an engine control unit (ECU) of the vehicle. Vehicle 1000 may also be equipped with a position sensor 3030, such as a GPS receiver and may also include a map database 3060 and memory units 3040 and 3050.

As discussed earlier, wireless transceiver 3072 may and/or receive data over one or more networks (e.g., cellular networks, the Internet, etc.). For example, wireless transceiver 3072 may upload data collected by vehicle control system 3000 to one or more servers, and download data from the one or more servers. Via wireless transceiver 3072, vehicle control system 3000 may receive, for example, periodic or on demand updates to data stored in map database 3060, memory 3040, and/or memory 3050. Similarly, wireless transceiver 3072 may upload any data (e.g., images captured by image acquisition unit 3020, data received by position sensor 3030 or other sensors, vehicle control systems, etc.) from vehicle control system 3000 and/or any data processed by processing unit 3010 to the one or more servers.

Vehicle control system 3000 may upload data to a server (e.g., to the cloud) based on a privacy level setting. For example, vehicle control system 3000 may implement privacy level settings to regulate or limit the types of data (including metadata) sent to the server that may uniquely identify a vehicle and or driver/owner of a vehicle. Such settings may be set by user via, for example, wireless transceiver 3072, be initialized by factory default settings, or by data received by wireless transceiver 3072.

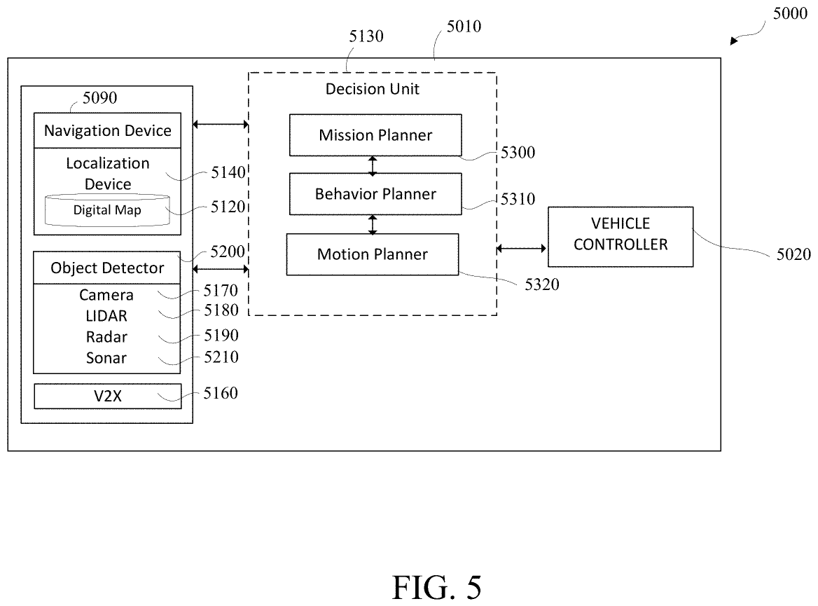

FIG. 5 is a diagram of an example of a vehicle system architecture 5000 in accordance with embodiments of this disclosure. The vehicle system architecture 5000 may be implemented as part of a host vehicle 5010.

Referring to FIG. 5, the vehicle system architecture 5000 includes a navigation device 5090, a decision unit 5130, object detector 5200, V2X communications 5160 and a vehicle controller 5020. The navigation device 5090 may be used by the decision unit 5130 to determine a travel path of the host vehicle 5010 to a destination. The travel path, for example, may include a travel route or a navigation path. The navigation device 5090, the decision unit 5130 and the vehicle controller 5020 may be collectively used to determine where to steer the host vehicle 5010 along a roadway such that the host vehicle 5010 is appropriately located on the roadway relative to, for example, lane markings, curbs, traffic signs, pedestrians, other vehicles, etc., determine a route based on a digital map 5120 that the host vehicle 5010 is instructed to follow to arrive at a destination, or both.

In order to determine where the host vehicle 5010 is located on the digital map 5120, the navigation device 5090 may include a localization device 5140, such as a GPS/GNSS receiver and an inertial measurement unit (IMU). A camera 5170, a radar unit 5190, a sonar unit 5210, a LIDAR unit 5180 or any combination thereof may be used to detect relatively permanent objects proximate to the host vehicle 5010 that are indicated on the digital map 5120, for example, traffic signals, buildings, etc., and determine a relative location relative to those objects in order to determine where the host vehicle 5010 is located on the digital map 5120. This process may be referred to as map localization. The functions of the navigation device 5090, the information provided by the navigation device 5090, or both, may be all or in part by way of V2I communications, V2V communications, vehicle-to-pedestrian (V2P) communications, or a combination thereof, which may generically be labeled as V2X communications 5160.

In some implementations, an object detector 5200 may include the sonar unit 5210, the camera 5170, the LIDAR unit 5180, and the radar unit 5190. The object detector 5200 may be used to detect the relative location of another entity, and determine an intersection point where another entity will intersect the travel path of the host vehicle 5010. In order to determine the intersection point and the relative timing of when the host vehicle 5010 and another entity will arrive at the intersection point, the object detector 5200 may be used by the vehicle system architecture 5000 to determine, for example, a relative speed, a separation distance of another entity from the host vehicle 5010, or both. The functions of the object detector 5200, the information provided by the object detector 5200, or both, may be all or in part by way of V2I communications, V2V communications, V2P communications, or a combination thereof, which may generically be labeled as V2X communications 5160. Accordingly, the vehicle system architecture 5000 may include a transceiver to enable such communications.

The vehicle system architecture 5000 includes a decision unit 5130 that is in communication with the object detector 5200, and the navigation device 5090. The communication may be by way of, but not limited to, wires, wireless communication, or optical fiber. The decision unit 5130 may include a processor(s) such as a microprocessor or other control circuitry such as analog circuitry, digital circuitry, or both, including an application specific integrated circuit (ASIC) for processing data. The decision unit 5130 may include a memory, including non-volatile memory, such as electrically erasable programmable read-only memory (EEPROM) for storing one or more routines, thresholds, captured data, or a combination thereof. The decision unit 5130 may include at least a mission planner 5300, behavior planner 5310 and motion planner 5320, which collectively determine or control route or path planning, local driving behavior and trajectory planning for the host vehicle 5010.

The vehicle system architecture 5000 includes a vehicle controller or trajectory tracker 5020 that is in communication with the decision unit 5130. The vehicle controller 5020 may execute a defined geometric path (which may be provided by the motion planner 5320 or the decision unit 5130) by applying appropriate vehicle commands such as steering, throttle, braking and the like motions to physical control mechanisms such as steering, accelerator, brakes, and the like that guide the vehicle along the geometric path. The vehicle controller 5020 may include a processor(s) such as a microprocessor or other control circuitry such as analog circuitry, digital circuitry, or both, including an application specific integrated circuit (ASIC) for processing data. The vehicle controller 5020 may include a memory, including non-volatile memory, such as electrically erasable programmable read-only memory (EEPROM) for storing one or more routines, thresholds, captured data, or a combination thereof.

The host vehicle 5010 may operate in automated mode where a human operator is not needed to operate the vehicle 5010. In the automated mode, the vehicle control system 5000 (using for example the vehicle controller 5020, the decision unit 5130, navigation device 5090, the object detector 5200 and the other described sensors and devices) autonomously controls the vehicle 5010. Alternatively, the host vehicle may operate in manual mode where the degree or level of automation may be little more than providing steering advice to a human operator. For example, in manual mode, the vehicle system architecture 5000 may assist the human operator as needed to arrive at a selected destination, avoid interference or collision with another entity, or both, where another entity may be another vehicle, a pedestrian, a building, a tree, an animal, or any other object that the vehicle 5010 may encounter.

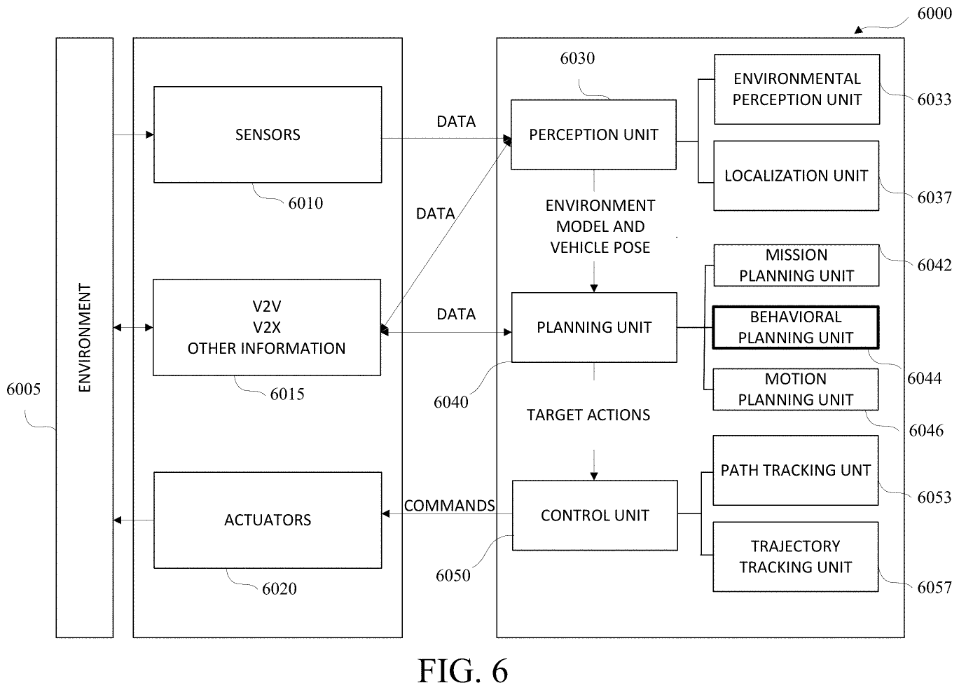

FIG. 6 is a diagram of an example of a vehicle control system 6000 in accordance with embodiments of this disclosure. The vehicle control system 6000 may include sensors 6010, and V2V, V2X and other like devices 6015 for gathering data regarding an environment 6005. The data may be used by a perception unit 6030 to extract relevant knowledge from the environment 6005, such as, but not limited to, an environment model and vehicle pose. The perception unit 6030 may include an environmental perception unit which may use the data to develop a contextual understanding of the environment 6005, such as, but not limited, where obstacles are located, detection of road signs/marking, and categorizing data by their semantic meaning. The perception unit 6030 may further include a localization unit which may be used by the AV to determine its position with respect to the environment 6005. A planning unit 6040 may use the data and output from the perception unit 6030 to make purposeful decisions in order to achieve the AV's higher order goals, which may bring the AV from a start location to a goal location while avoiding obstacles and optimizing over designed heuristics. The planning unit 6040 may include a mission planning unit or planner 6042, a behavioral planning unit or planner 6044, and a motion planning unit or planner 6046. The mission planning unit 6042, for example, may set a strategic goal for the AV, the behavioral planning unit 6044 may determine a driving behavior or vehicle goal state, and the motion planning unit 6046 may compute a trajectory. The perception unit 6030 and the planning unit 6040 may be implemented in the decision unit 5130 of FIG. 5, for example. A control unit or controller 6050 may execute the planned or target actions that have been generated by the higher-level processes, such as the planning unit 6040. The control unit 6050 may include a path tracking unit 6053 and a trajectory tracking unit 6057. The control unit 6050 may be implemented, by the vehicle controller 5020 shown in FIG. 5.

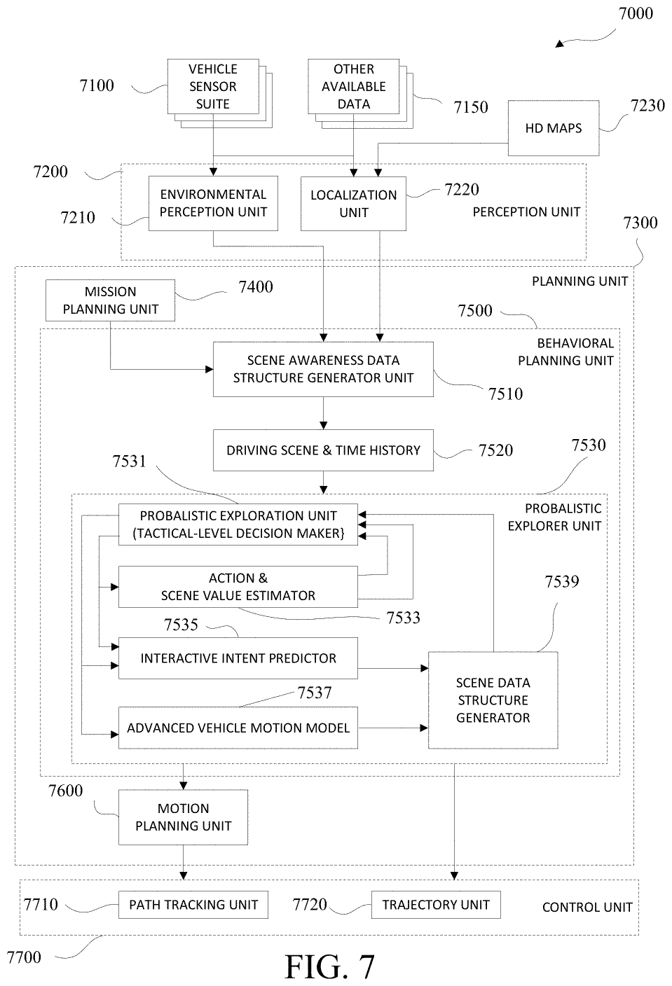

FIG. 7 is a diagram of an example of an autonomous vehicle system 7000 including a behavior planning system and flow in accordance with embodiments of this disclosure. As described herein, the behavior planning system may preclude the use of human data and have no supervised learning. The system may be reward-driven based on human desires to achieve human-like behavior. The system may a “tabula rasa” based system where a neural network may be initialized with random weights and may start driving accordingly. The behavior planning system may use as inputs a current driving scene state and driving scene state history as described herein and may learn by driving on the desired driving scenes. In an implementation, the behavior planning system may also learn by driving against itself, where the other actors are previous versions of itself. Based on these inputs, the system may use a single, combined policy (driving actions) and value (cost function) network, which may be implemented as residual networks and a Monte Carlo Tree Search (MCTS) which may not use randomized MC rollouts and may use a neural network to evaluate actions and value. The system may provide more generality in problem solving due to decreased system complexity.

The autonomous vehicle system 7000 may include a vehicle sensor suite 7100 and information intake devices 7150 connected to or in communication with (collectively “in communication with”) a perception unit 7200, which may include an environmental perception unit 7210 and a localization unit 7220. The localization unit 7220 may in communication with HD maps 7230. The perception unit 7200 may be in communication with a planning unit 7300, which may include a mission planning unit 7400 in communication with a behavioral planning unit 7500, which in turn may be in communication with a motion planning unit 7600. The behavioral planning unit 7500 and the motion planning unit 7600 may be in communication with a control unit 7700, which may include a path tracking unit 7710 and a trajectory tracking unit 7720. The behavioral planning unit 7500 may include a scene awareness data structure generator 7510 in communication with the environmental perception unit 7210, the localization unit 7220, and the mission planning unit 7400. A driving scene and time history 7520 may be populated by the scene awareness data structure generator 7510 and may be used as inputs to a probabilistic explorer unit 7530. The probabilistic explorer unit 7530 may include a probabilistic exploration unit 7531 in communication with an action and scene cost/value estimator 7533, an interactive intent prediction unit 7535, and an advanced vehicle motion model unit 7537. The perception unit 7200 and the planning unit 7300 may be implemented by the decision unit 5130 and the localization device 5140 of FIG. 5. The control unit 7700 may be implemented by the vehicle controller 5020 of FIG. 5.

The vehicle sensor suite 7100 and the information intake devices 7150 such as V2V, V2C and the like gather information regarding the vehicle, other actors, road conditions, traffic conditions, infrastructure and the like. The environmental perception unit 7210 may determine a contextual understanding of the environment, such as, but not limited, where obstacles are located, detection of road signs/marking, from the vehicle sensor suite 7100 data and may categorize the vehicle sensor suite 7100 data by their semantic meaning. The localization unit 7220 may determine a vehicle position with respect to the environment using the vehicle sensor suite 7100 data and the information intake devices 7150 data.

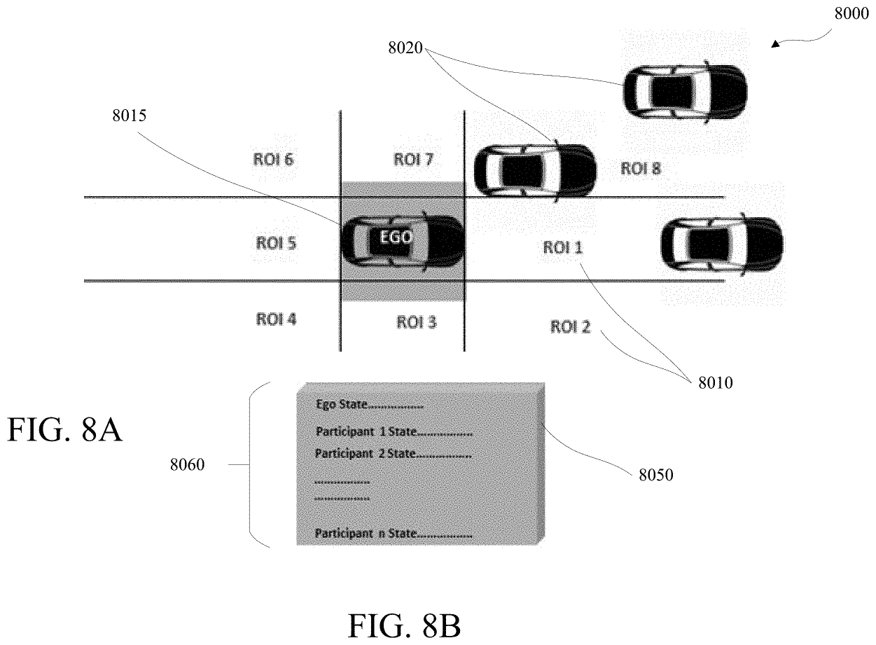

The scene awareness data structure generator 7510 may determine a current driving scene state based on the environmental structure provided by the environmental perception unit 7210, the vehicle position provided by the localization unit 7220, and a strategic-level goal provided by the mission planning unit 7400. The current driving scene state is saved in the driving scene and time history 7520, which may be implemented as a data structure in memory, for example. Reference is now also made to FIG. 8A and FIG. 8B, which are diagrams of an example of a driving scene 8000 and a driving scene state 8050 in accordance with embodiments of this disclosure. The driving scene 8000 may include multiple regions of interest (ROI) 8010, where a ROI 8010 may have none, one or more actors or participants 8020 or a vehicle 8015. For example, the driving scene 8000 illustrates nine ROIs, with one ROI for the vehicle 8015 (e.g. the host vehicle is labeled as “Ego”). In this example, ROI 1 has one participant 8020 and ROI 8 has two participants 8020. For each ROI 8010, the driving scene state 8050 may include one or more rows of participant states 8060 for each of the one or more participants 8020 or the vehicle 8015. Each participant state 8060 may include position, velocity, heading angle, distance from center of the road, distance from left and right edges of the road, current road speed limit, a strategic-level goal for a vehicle (Ego) and the like.

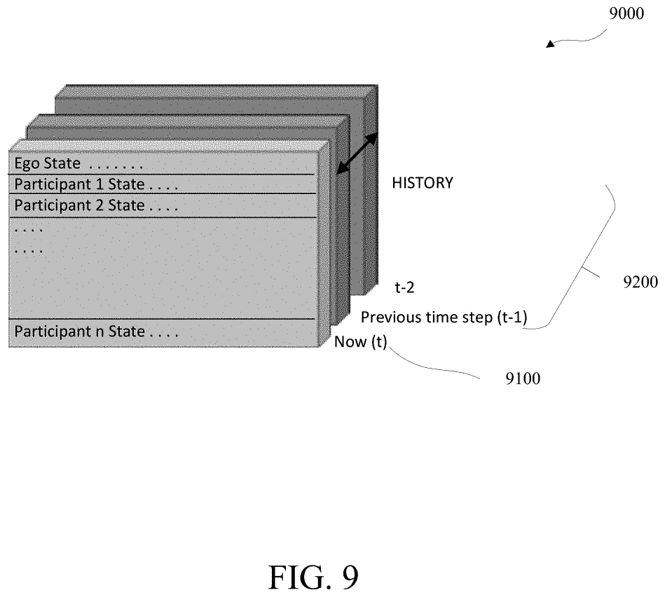

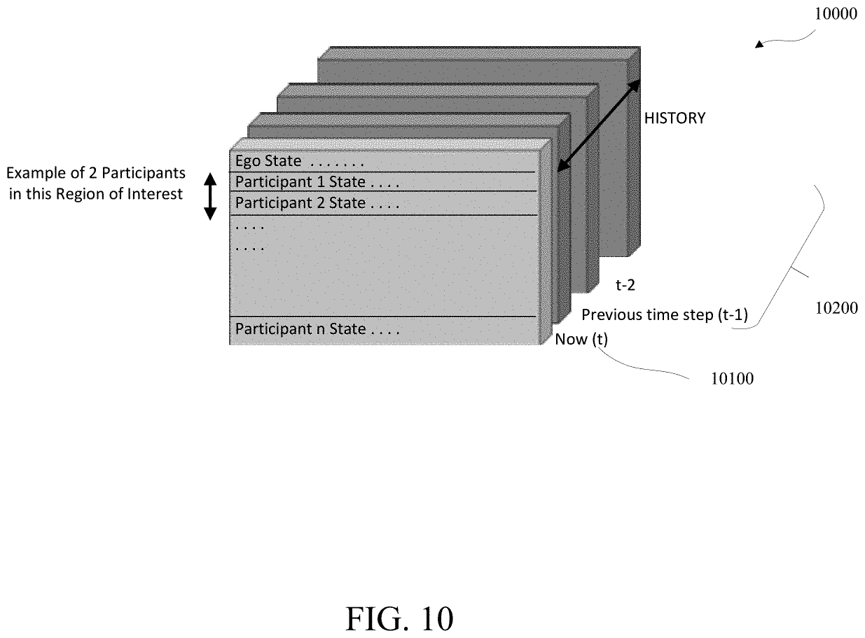

Reference is now also made to FIG. 9, which is a diagram of an example of a driving scene and time history 9000 in accordance with embodiments of this disclosure. Driving scene and time history 9000 may be a multi-dimensional matrix or data structure stored in a memory. Driving scene and time history 9000 may include a feature map or plane 9100 for a current driving scene state and two feature maps 9200 for two previous driving scene states at a defined time step. Reference is now also made to FIG. 10, which is a diagram of another example of driving scene and time history 10000 in accordance with embodiments of this disclosure. Driving scene and time history 10000 may be a data structure stored in a memory. Driving scene and time history 10000 may include a feature map or plane 10100 for a current driving scene state and two or more feature maps 10200 for two or more previous driving scene states at a defined time step. In an implementation, the driving scene and time history 7520, the driving scene and time history 9000, and the driving scene and time history 10000 may provide a temporal feature for temporal patterns for both the vehicle 8015 and other participants 8020 trends, for example. In an implementation, the driving scene and time history 7520, the driving scene and time history 9000, and the driving scene and time history 10000 may be used to predict the intent of all other participants. In an implementation, the driving scene and time history 7520, the driving scene and time history 9000, and the driving scene and time history 10000 may provide an understanding of the connection between the past and the future driving scene states and may be used to drive policy (drive action) proper learning and recommendation as described herein.

Referring back to FIG. 7, the probabilistic explorer unit 7530 may receive or obtain the strategic-level goal, a current driving scene and driving scene time history from the driving scene and time history 7520. The action and scene value (against the strategic goal) estimator 7533 may output a probability distribution of actions and estimated scene value, where actions with higher probabilities may yield higher value future states. A set of actions may be sampled from this probability distribution. The sampled probability distribution of actions (at a steady state) may reflect how many times a specific action has been taken and the estimated scene value may reflect what is the value of being in the current state versus being in another state with respect to the strategic-level goal. The probability distribution of actions may be used as a short term parameter and the estimated scene value may be used as a long term parameter as the action and scene value estimator 7533 learns from the multitude of current driving scenes, driving scene state history and virtual scene states as described herein. For example, the action and scene value estimator 7533 may learn to suggest a set of actions (probability distribution of actions) that under this specific driving scene and time history, may lead to a higher scene value.

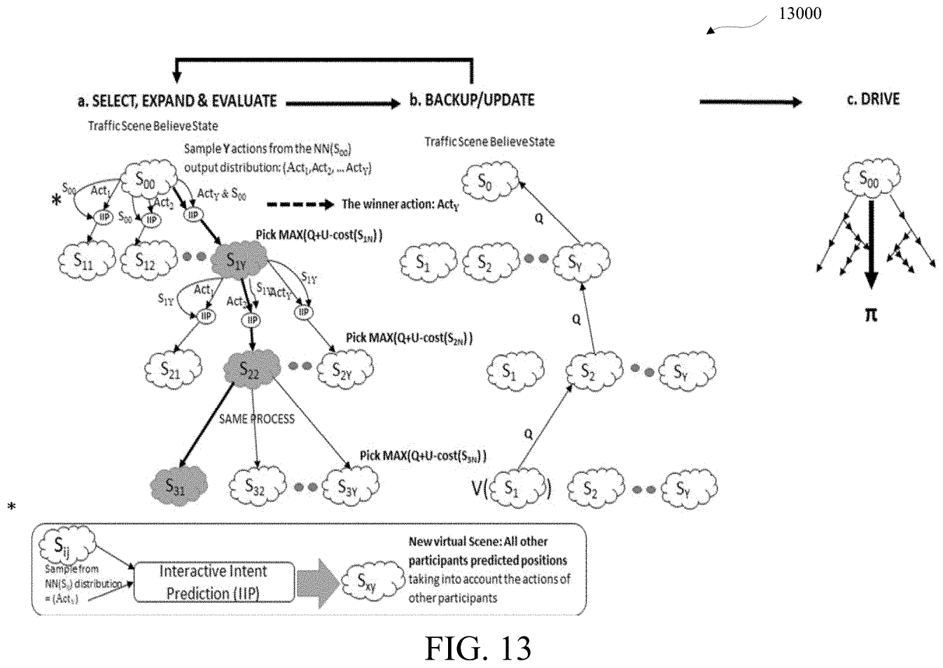

For example, with reference also to FIG. 13, a scene (such as S₀₀) may represent a snapshot of a scene having an estimated scene value and from which sampled actions are taken to expand the scene (i.e. the node). Selection of a particular action maximizes the value (as against a strategic goal) and a cost (as described herein below). In particular, the selected action (i.e. an edge) aₜ=arg maxₐ(Q(sₜ, a)+U(sₜ, a)−cost(Sₜ,a)), where

$$U ( s , a ) = c * P ( s , a ) \frac{\sqrt{{Σ}_{b} N ( s , b )}}{1 + N ( s , a )}$$

and a=driving action, and where N(S,a) is the number of times an action “a” may have been taken when in a state S. That is, each simulation traverses the tree by selecting the edge with a maximum action value Q, plus a bonus u(P) that depends on a stored prior probability P for that edge. A leaf node s_{L} may be expanded, and each edge (s_{L}, a) is initialized as: [N(s_{L}, a)=0; Q(s_{L}, a)=0; W(s_{L}, a)=0; P(s_{L}, a)=pₐ]. The new node is processed once by the policy network (as described herein) and the output probabilities are stored as prior probabilities P for each action. At the end of a simulation, the leaf node is evaluated using the value network (as described herein). Each edge on the path is backpropogated or backed up as N(s, a)=N(s, a)+1, W(s, a)=W(s, a)−v, Q(s, a)=W(s, a)/N(s, a). This permits changing which nodes and actions are taken in case the scene value worsens during node expansion.

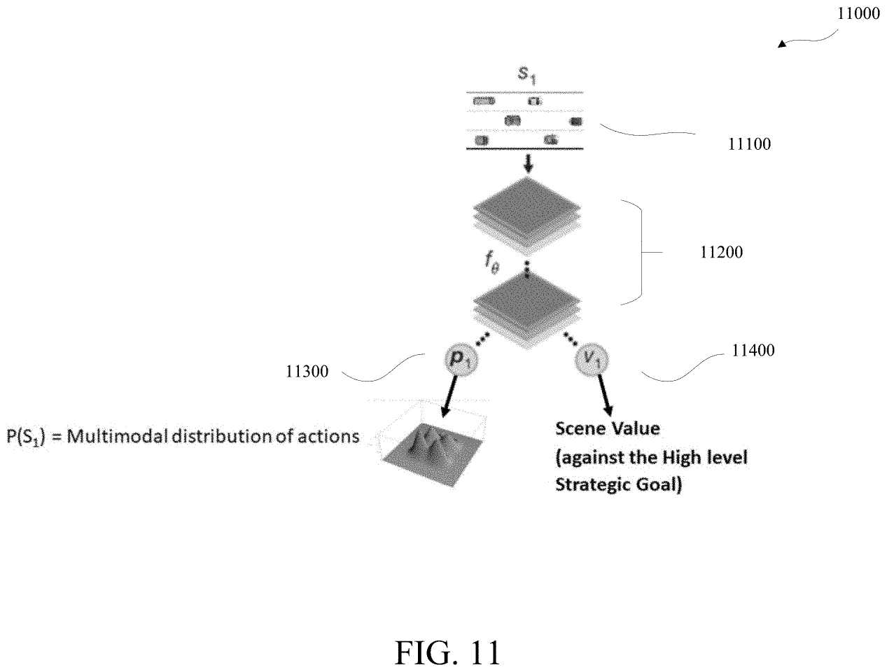

The action and scene value estimator 7530 may combine a policy (driving actions) head and a value (driving scene value evaluated against the strategic goal provided the mission planner 5300 or mission planning unit 7400) head into a single network. In an implementation, the action and scene value estimator 7530 may be implemented as a neural network, such as for example, a deep neural network (DNN), a convolutional neural network (CNN) and the like. FIG. 11 is a diagram of an example of a combined policy and value network 11000 implemented as a multi-layer neural network (NN) 11200 in accordance with embodiments of this disclosure. For example, the NN 11200 may be a multi-layer perceptron (MLP). The network 11000 may receive as input a full driving scene state 11100 (denoted S₁) which includes a current driving scene state and a driving scene time history. The multi-layer NN 11200 may process or analyze the full driving scene state 11100 and outputs a probability distribution of actions, known as policy 11300, (denoted Pi) and an estimated scene value 11400 (denoted V₁). In a multi-dimensional action space, policy 11300 may be a multimodal bivariate distribution of vehicle actions or parameters, such as yaw rate and acceleration changes, that may be implemented by the vehicle or may be a probability distribution of discrete actions, also known as maneuvers. For example, P(S₁)=(ω, acc) or P(S₁)=maneuverX. The estimated scene value 11400 may predict, based on a state S₁ and its history, the value of a scene against the high-level strategic goal provided by the mission planning unit 7400, for example. A value prediction may be made to determine if it is more useful to stay in the left lane or move to the right lane for an upcoming right turn, for example.

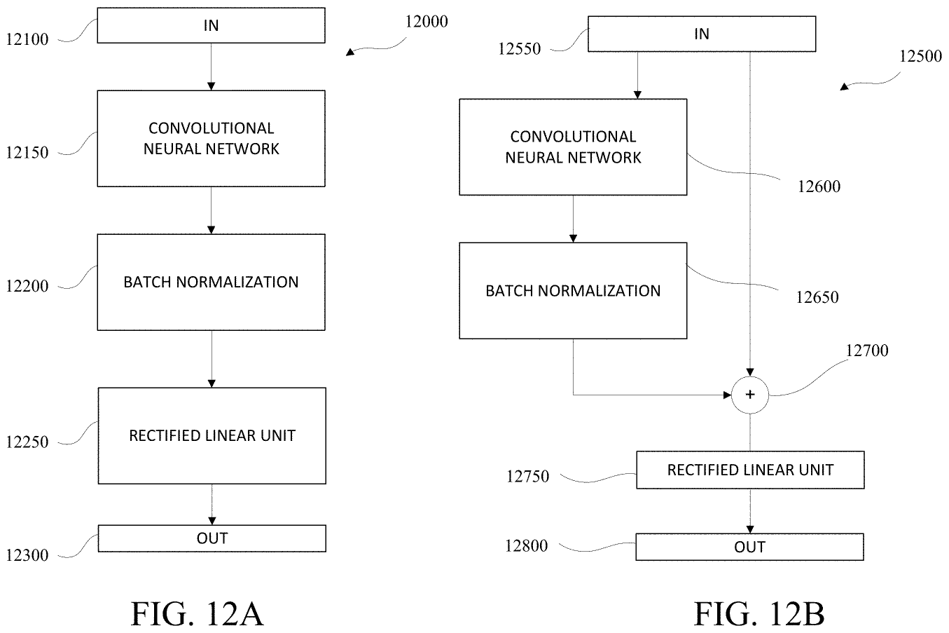

FIG. 12A is a diagram of an example neural network 12000 in accordance with embodiments of this disclosure. In this implementation, inputs 12100, such as a current driving scene state and a driving scene state history, may be applied to a neural network 12150, such as a CNN, for example. The activations of each layer in the neural network 12150 may be normalized using a batch normalization unit or layer 12200 and then processed by a rectified linear unit or layer 12250, which may perform a threshold operation to each element of the input where any value less than zero is set to zero, or otherwise appropriately set. Outputs 12300 may include a probability of actions and estimated scene values as described herein.

FIG. 12B are diagrams of an example residual network 12500 in accordance with embodiments of this disclosure. In this implementation, inputs 12550, such as a current driving scene state and a driving scene state history, may be applied to a neural network 12600, such as a CNN, for example. The activations of each layer in the neural network 12650 may be normalized using a batch normalization unit or layer 12650. In addition, the inputs 12550 may bypass the neural network 12600 and be summed with the outputs of the batch normalization unit or layer 12650. The signal summation may then be processed by a rectified linear unit or layer 12750, which may perform a threshold operation to each element of the input where any value less than zero is set to zero, or otherwise appropriately set. Outputs 12800 may include actions and estimated scene value as described herein. In this instance, the residual network 12500 allows a gradient signal that is used for training the network to pass straight through the layers. This may be beneficial during early stages of the network training process when the network is not really doing anything useful yet, as it allows useful learning signals to pass through those layers in order to fine tune other layers.

Referring back to FIG. 7, the probabilistic explorer unit 7530 may output a vehicle goal state to the motion planning unit 7600 or a vehicle low-level control action to the control unit 7700 depending on the temporal proximity to a prediction horizon or defined time horizon. In particular, the probabilistic exploration unit 7531 may make tactical-level decisions based on the outputs of the action and scene value estimator 7533, for example, the probability distribution of actions and estimated scene value, and the outputs of the scene data structure generator 7539, for example, a virtual driving scene generated from the outputs of the Interactive Intent Prediction (IIP) unit 7535, (estimated trajectories for all other actors), and the advanced vehicle motion model 7537, (estimated trajectory for AV), where the tactical-level decision relates to a sequence of actions that are likely to produce successful outcomes. This may be iteratively performed until occurrence of an event horizon or predefined threshold and culminates in the probabilistic explorer unit 7530 outputting the vehicle goal state, or the vehicle low-level control actions. For example, a vehicle goal state may be defined by x, y, velocityₓ, velocity_{y}, heading, and the vehicle low-level control actions may be defined by steering, brake/acceleration commands.

Referring also to FIG. 13, the IIP unit 7535 may output estimated trajectories or predicted positions for all other actors (i.e. not the AV or host vehicle) taking into account the actions of other actors based on the driving scene and exploring or sample action selected by the probabilistic exploration unit 7531. The interactive intent prediction unit 7570 may be implemented as using the method of U.S. patent application entitled “METHOD AND APPARATUS FOR INTERACTION AWARE TRAFFIC SCENE PREDICTION”, filed concurrently, which is incorporated by reference in its entirety, a Long Short-Term Memory (LSTM) Network, a Generative Adversarial Network (GAN), a Hierarchical Temporal Memory approach and the like.

The advanced vehicle motion model 7537 may output estimated trajectories or predicted positions for the vehicle based on the driving scene and exploring or sample action selected by the probabilistic exploration unit 7531. The advanced vehicle motion model 7537 may estimate an updated vehicle state using a vehicle dynamic model based on the initial state, time interval dt, and control input. In an implementation, a vehicle dynamic model may have an initial state, a control input, and time as inputs and may have an updated state as an output. For example, the control input may be applied to the initial state over a time dt on the vehicle dynamic model to generate an updated state.

The scene data structure generator 7539 may use the outputs of the interactive intent prediction unit 7535 and the advanced vehicle motion model 7537 to generate a virtual new driving scene, which may then be fed into the probabilistic exploration unit 7531.

The process or sequence may be executed on an iterative basis relative to the prediction horizon or a defined time horizon. In an implementation, the vehicle goal state may be determined at any time within the defined time horizon. In an implementation, the advanced vehicle motion model 7537 may output the vehicle goal state to the motion planning unit 7600. In an implementation, if the determination is made within a temporal proximity of the defined time horizon, the advanced vehicle motion model 7537 or probabilistic exploration unit 7531 may output the vehicle low-level control actions to the control unit 7700.

The motion planning unit 7600 may output vehicle low-level control actions or commands based on the vehicle goal state using known or new techniques. The vehicle low-level control actions may be sent to the control unit 7700.

The control unit 7700, via the path tracking unit 7710 and trajectory tracking unit 7720, may apply the vehicle low-level control actions, such as steering, throttle, braking and the like motions, to physical control mechanisms such as steering, accelerator, brakes, and the like that guide the vehicle along a geometric path.

FIG. 13 is a diagram of an example of probabilistic exploration flow 14000 that may be performed by the probabilistic explorer unit 7530 and the probabilistic exploration unit 7531 in accordance with embodiments of this disclosure. In an implementation, the probabilistic exploration unit 7531 may be implemented as a Monte Carlo Tree Search (MCTS) which may not employ randomized Monte Carlo rollouts and may use the NN for evaluation purposes or as a guiding expert as to the actions to be explored. The MCTS uses the recommended, sampled or exploration actions (collectively recommended actions) (which may be in the continuous and therefore infinite action space such as steering and acceleration/brake commands or in a discretized version of this space), such as steering choice between 0°, 5°, 10°, 20° and so on for each side or even higher tactical actions such as “change lane—left”, “change lane—right”, “follow vehicle-same lane”, and the like. These recommended actions by the NN may be input into the interactive intent prediction unit 7535, for example, jointly with the actual or current scene and the scene time history to predict what all the other actors would do if the recommended actions are taken and accounting for what was previously done as related by the scene history. The recommended actions may also be input into the advanced vehicle motion model 7537, for example, to predict the AV trajectory. The scene data structure generator 7539, for example, may output a new virtual/predicted scene that is then evaluated by the NN (i.e. the action and scene value estimator 7533 is executed by the probabilistic exploration unit 7531) to generate a probability distribution of actions and an estimated value of the scene for comparison against the high-level strategic goal. This process will expand one single node S₁ from an initial state S₀. Since the recommended actions by the NN are probabilistic, the X actions with the highest probabilities may be chosen or selected. The number X may vary dynamically to control the exploration. That is, more actions may be chosen at the beginning of the tree expansion and less actions may be chosen at later times in the tree expansion.

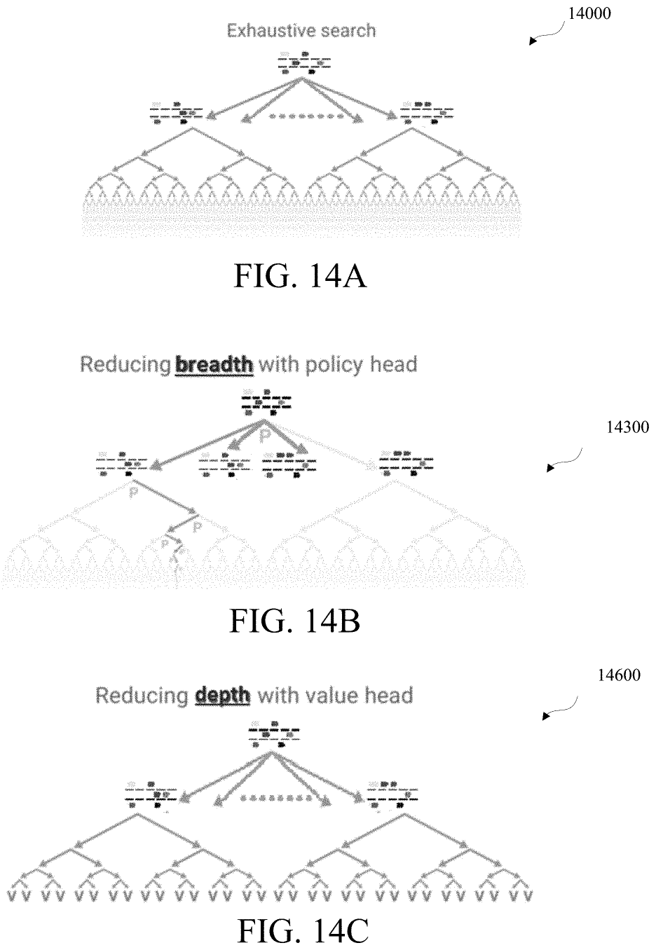

In this implementation, the use of a combined policy (actions) and value based NN may make the MCTS search or expansion tractable as described with respect to FIG. 14A, FIG. 14B and FIG. 14C, which are diagrams of an exhaustive search, policy-based reduction search and value-based reduction search in accordance with embodiments of this disclosure. FIG. 14A illustrates a standard exhaustive search 14000 where all branches and nodes may be involved. FIG. 14B illustrates the effects of reducing the breadth of the search 14300 by the policy head of the single, combined network and FIG. 14C illustrates the effects of reducing the depth of the search 14600 by the value head of the single, combined network. The example shown in FIG. 14A, FIG. 14B and FIG. 14C is illustrative and the number of actions from a given state may vary in practice there may be several hundred actions and the tree would be vast. Search tractability may be increased by using the combined policy (actions) and value based NN described herein. The policy head of the combined policy (actions) and value based NN may be used to reduce the breadth of the search tree. The policy head may suggest actions to take in each position and may reduce the breadth of the search by only considering actions that are recommended by the policy head. That is, instead of searching the hundreds or so actions from each state, expansion in the search tree may be done from a defined or selected number of actions to dramatically narrow the set of possible sequences (“branches”) that may need to be considered. The value head of the combined policy (actions) and value based NN may be used to reduce the depth of the search tree. The value head may predict the value of the scene (value against the high-level strategic goal) from any position and this means that value head may replace any subtree of the search tree with a single number. That is, instead of searching all the way to the end of the drive (reaching the strategic goal), the action sequence may be truncated at a leaf node and the subtree that we would have had to search systematically all the way to the end of the drive may be replaced with a single evaluation the value head of the NN. This may reduce the size of the search space.

Referring back to FIG. 13, the probabilistic exploration flow 13000 may include a root scene state, S₀ from which selection, expansion and evaluation progresses to a drive action. In terms of overall flow, at every node Sₜ, aₜ is chosen such that aₜ=arg maxₐ(Q(Sₜ, a)+U(Sₜ, a)−cost(Sₜ,a)), where

$$U ( S , a ) = c * P ( S , a ) \frac{\sqrt{{Σ}_{b} N ( S , b )}}{1 + N ( S , a )}$$

and a is the driving action tuple (ω, acc) and N(S,a) is the number of times an action a has been taken when in a scene state S. As this is a continuous state, and a continuous action state problem, N(S, a) may be defined to account for “similar” actions in “similar” scene states. A leaf node S_{L} is expanded, and each edge (S_{L}, a) is initialized as: N(S_{L}, a)=0; Q(S_{L}, a)=0; W(S_{L}, a)=0; and P(S_{L}, a)=pₐ. Each edge (S; a) in the search tree may store a prior probability p(S; a), a visit count N(S; a) and a mean action value Q(S; a). In a continuous action space, all selected actions will be different (for example, 28.569 is different than 28.568) and in these cases it is not possible, practical or useful to count the number of times an action is used as each action is different. Therefore, in the continuous action space, techniques such as Kernel Regression may be used to estimate the value (the count) of an action by comparing how many “similar” actions have been taken. For example, a selection function for MCTS may be Upper Confidence Bounds Applied to Trees (UCT) [Kocsis and Szepesvari, 2006, incorporated herein by reference] only applicable to discrete actions (that may be counted). Each node maintains the mean of the rewards/value received for each action Q, and the number of times each action has been used, N. Every edge on the path may be backed up by setting: N(S, a)=N(S, a)+1; W(S, a)=W(S, a)±v(S); and

$$Q ( S , a ) = \frac{W ( S , a )}{N ( S , a )} ,$$

where “v” A drive action may be maximum of:

$$π ( a \vert {S}_{0} ) = \frac{{N ( {S}_{0} , a )}^{\frac{1}{τ}}}{{Σ}_{b} {N ( {S}_{0} , b )}^{\frac{1}{τ}}}$$

as τ→0 in real time, i.e. actual driving and not training.

For example, a sample of Y tuple actions is sampled from the output distribution of actions for S₀, i.e., P(S₀)=(ω₁, acc₁), (ω₂, acc₂), . . . , (ω_{Y}, acc_{Y}). As shown in FIG. 13, for each sampled action, the interactive intent prediction unit 7535 may determine predicted positions of other participants taking into account the actions of the other participants, i.e., the (ω_{X1}, acc_{X1}) term, and may feed this back to the probabilistic exploration unit 7531 via the scene data structure generator 7539 (i.e. as a virtual scene), which in turn runs the NN (action and scene value estimator 7533) to generate a probability distribution of actions and a value for the next scene. A node may be selected which maximizes max (Q+U-cost(Sᵢ), where cost(Sᵢ) may be any one or more of, for example, lane change cost, time difference cost, S difference cost, distance to goal cost, collision cost, buffer distance cost, stays on road cost, exceeds speed limit cost, efficiency cost, total acceleration cost, maximum acceleration cost, or maximum jerk cost. This cost may be the cornerstone since a value head of the NN may be trained against this “Perfect” function value which represents human priorities and values of what is a “Good and Safe” behavior. In an implementation, this “perfect” cost function may be an equation. In an implementation, this “perfect” cost may be generated by using Inverse Reinforcement Learning (IRL) techniques or others. This approach may allow avoiding of hardcoding of all traffic rules and the desired/socially acceptable driving behaviors (rewards and penalties) since in different regions these will be different and may generalize and be able to show the different possibilities to generate a cost/reward function since reinforcement learning is about taking suitable actions to maximize rewards in a particular situation. The expansion of the tree will go on until a terminal state is reached or after all the computational resources available are used (i.e. a time limit). At that point, a path of the nodes may be selected using max (Q+U−cost(Si)). The determined search tree path, including nodes and the like, may then be backed up and updated.

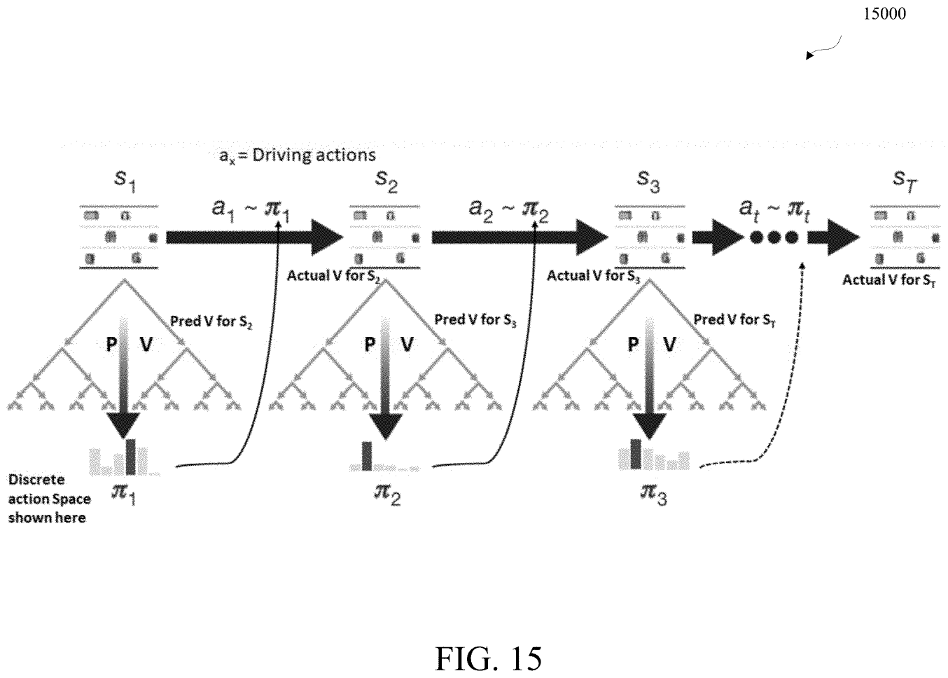

FIG. 15 is a diagram of an example of a simulated drive for MCTS training 15000 in accordance with embodiments of this disclosure. In each iteration, a predefined scenario may be driven a thousand times until a predefined termination (either task accomplished or crash/outside the road), and the like. A decision depth, simulation or prediction horizon (τ) may be selected. That is, for each policy (π), a defined number of MCTS simulations are executed, where the depth may be controlled by time or by a fixed amount of depth levels reached. In an implementation, for the first X moves, τ=1 to encourage exploration (selects moves proportionally to their visit count in MCTS). For the reminder of the simulated drive τ→0. Additional exploration may be achieved by adding a Dirichlet noise to the prior probabilities in the root node S₀. i.e., P(S, a)=(1−ε)pₐ+εηₐ, where ηₐ˜Dir(0.03) and ε=0.25. This noise may ensure that all moves may be tried, but the search may still overrule bad moves.

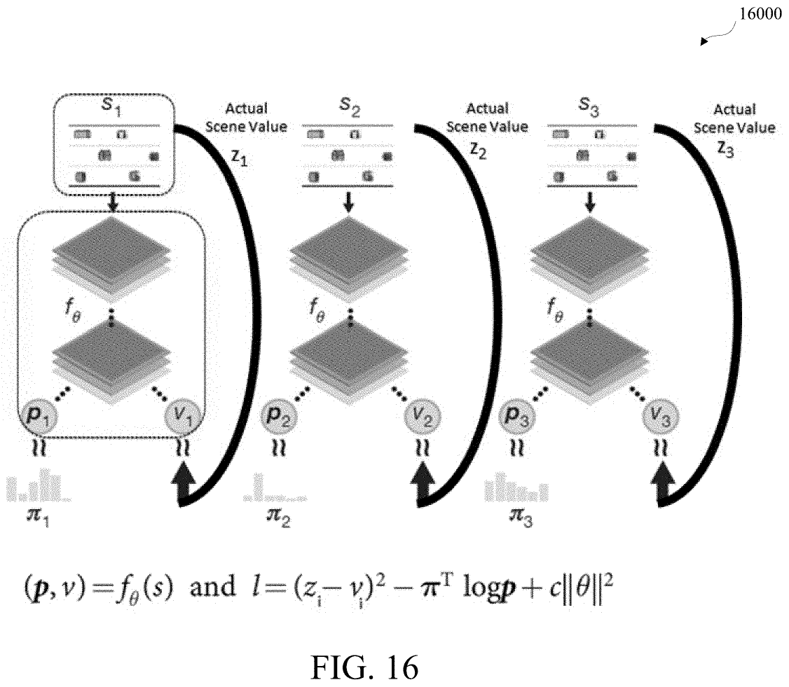

FIG. 16 is a diagram of an example of neural network training 16000 in accordance with embodiments of this disclosure. Each neural network 16100 may take a full driving scene state Sₜ as an input as described herein. The scene state Sₜ may pass through many convolutional layers with parameters θ (the NN weights that are automatically adjusted via backpropagation while training the NN), and outputs both a multimodal distribution Pₜ, representing a probability distribution over discrete or continuous actions, and a scalar value vₜ, representing the final predicted scene value at state Sₜ as compared against the high-level strategic goal. The neural network parameters θ may be updated to maximize the similarity of the policy vector Pₜ to the search probabilities at and to minimize the error between the predicted scene value vₜ and the actual scene value zₜ for every scene. For example:

(p,ν)=f_{θ}(s) and l=(zᵢ−νᵢ)²−π^{T} log p+c∥θ∥²

where the parameters θ are adjusted by gradient descent on a loss function “l” that sums over mean-squared error and cross-entropy losses respectively as shown.

The MCTS first training step of FIG. 15 and NN training of FIG. 16 may be iterated a number of times, and a better drive action (as determined against the cost function) may be determined each time. A current network may be updated with both, the policies πᵢ (outcome of the MCTS for each state Sᵢ) and the final value/cost.

Described herein is search-based policy iteration, which may include a search-based policy improvement and search-based policy evaluation. The search-based policy improvement may be shown by running MCTS search using a current network and showing that actions selected by MCTS are better actions as opposed to actions selected by a raw network (see Howard, R. Dynamic Programming and Markov Processes (MIT Press, 1960), and Sutton, R. & Barto, A. Reinforcement Learning: an Introduction (MIT Press, 1998). These search probabilities (MCTS—policy head output) usually select much stronger actions than the raw actions probabilities p of the neural network fₐ(S). MCTS may therefore be viewed as a powerful policy improvement operator. Drive with search, using the improved MCTS-based policy to select each action(s), then using each new scene value z as a sample of the value, may be viewed as a powerful policy evaluation operator. The search-based policy improvement may include deciding final action by minimizing the cost and evaluating an improved policy by the average outcome.

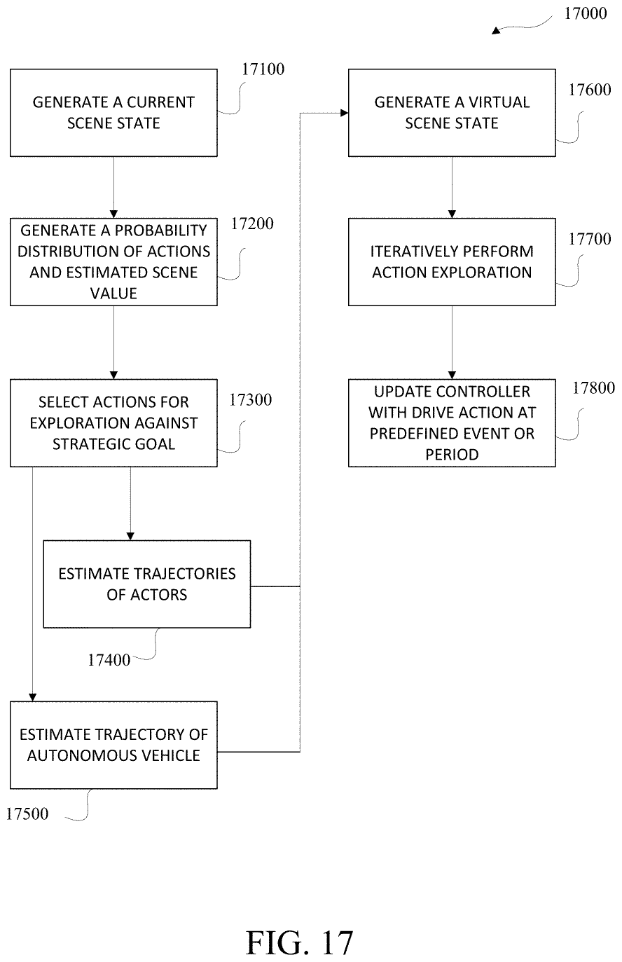

FIG. 17 is a diagram of an example of a technique or method 17000 for decision making for an autonomous vehicle (AV) in accordance with embodiments of this disclosure. The method 17000 includes: generating 17100 a current scene state from environmental information and a strategic goal; generating 17200 a probability distribution of actions and estimated scene value based on driving scene state and time history; exploring 17300 selected actions against the strategic goal; estimating 17400 trajectories of actors other than the AV based on at least the scene state and time history and the selected actions; estimating 17500 trajectories of the AV based on at least the selected actions; generating 17600 a virtual scene state from the estimated trajectories of the actors and the AV; iteratively performing 17700 action exploration using at least the virtual scene state; updating 17700 a controller with drive actions to control the AV at a defined event or period. For example, the technique 17000 may be implemented, in part and as appropriate, by the decision unit 5130 shown in FIG. 5, the motion planner 5320 shown in FIG. 5, the control system 1010 shown in FIG. 1, the processor 1020 shown in FIG. 1 or FIG. 2 or the processing unit 3010 shown in FIG. 3 or FIG. 4.

The method 7000 includes generating 17100 a current scene state from environmental information and a strategic goal. In an implementation, the environmental information is gathered from vehicle sensor suites and the other information intake devices such as V2V, V2C and the like. In an implementation, the environmental information may include information regarding the vehicle, other actors, road conditions, traffic conditions, infrastructure and the like. In an implementation, a contextual understanding of the environment may be determined from the environmental information in terms of where obstacles are located, detection of road signs/marking. The information may be used to determine a vehicle position with respect to the environment. In an implementation, the current scene state is stored in a driving scene and time history data structure, which includes multiple previous driving scenes. Each driving scene may contain information about all relevant actors and the AV including position, velocity, heading angle, distance from center of the road, distance from left and right edges of the road, current road speed limit, a strategic-level goal for the AV and the like.

The method 7000 includes generating 17200 a probability distribution of actions and an estimated scene value based on driving scene state and time history as described herein. In an implementation, a neural network may be used to generate a multimodal distribution of vehicle actions or parameters and estimated scene values. In an implementation, the neural network may be a combined policy (actions) and value network.

The method 7000 includes selecting 17300 actions for exploration against the strategic goal as described herein. In an implementation, the selected actions (sample actions) may be the actions with highest probability. The policy head of the combined policy (actions) and value based NN may be used to reduce the breadth of a search tree. The policy head may suggest actions to take in each position and may reduce the breadth of the search by only considering actions that are recommended by the policy head. The value head of the combined policy (actions) and value based NN may be used to reduce the depth of the search tree. The value head may predict the value of the scene (value against the high-level strategic goal).

The method 7000 includes estimating 17400 trajectories of actors other than the AV based on at least the scene state and time history and the selected actions. In an implementation, the estimated trajectories or predicted positions for all other actors (i.e. not the AV or host vehicle) may be output by taking into account the actions of other actors based on the driving scene and the selected sample action.

The method 7000 includes estimating 17500 trajectories of the AV based on at least the selected actions. In an implementation, estimated trajectories or predicted positions for the AV may be output based on the driving scene and selected sample action.

The method 7000 includes generating 17600 a virtual scene state from the estimated trajectories of the other actors and the AV. In an implementation, the virtual scene state is implemented in a feedback loop to evaluate further selected sample actions against the virtual scene state.

The method 7000 includes iteratively performing 17700 action exploration using at least the virtual scene state. In an implementation, the exploration process may be iteratively executed or performed to determine a sequence of actions that may reach the strategic goal by using updated actor and AV trajectories and the virtual scene state.

The method 7000 includes updating 17700 a controller with drive actions to control the AV at a defined event or period. In an implementation, a motion planner may receive a vehicle goal state from which vehicle low-level control actions or commands may be generated and sent to a controller. In an implementation, vehicle low-level control actions or commands may be sent the controller if a decision is near a defined time period, event horizon or the like.

In general, a method for behavioral planning in an autonomous vehicle (AV) includes generating a current driving scene state from environment data and localization data. A probability of distribution of actions and an estimated scene value is generated based on the current driving scene state, driving scene state history and a strategic vehicle goal state. An action is selected from the probability of distribution of actions. Estimated trajectories of non-AV actors are determined based on the selected action, the current driving scene state, the driving scene state history, and the strategic vehicle goal state. Estimated trajectory of the AV is determined based on at least the selected action and the estimated scene value. A drive action is determined based on maximizing scene value to reach the strategic vehicle goal state. A controller is updated with one of a trajectory or commands to control the AV, where the trajectory or the commands are based on determined drive actions. In an implementation, the method further includes generating a virtual scene state based on at least the estimated trajectory of the AV and the estimated trajectories of non-AV actors. In an implementation, each type of scene state includes information about AV and non-AV actors in the scene, and where the information includes at least position, velocity, heading angle, distance from center of the road, distance from left and right edges of the road, current road speed limit, and a strategic-level goal for the AV. In an implementation, the method further includes generating a probability of distribution of actions and an estimated scene value based on at least the virtual scene state. In an implementation, the method further includes iteratively performing at least the selecting the action, determining the estimated trajectories of non-AV actors, determining the estimated trajectory of the AV, generating the virtual scene state and generating the probability of distribution of actions and estimated scene value based on at least the virtual scene state until an event horizon. In an implementation, the method further includes generating a contextual understanding of environment from the environment data and determining an AV position with respect to the contextual understanding of the environment. In an implementation, scene state tree exploration from a given scene state to a next scene state are reduced in breadth and depth scope using a combined policy/actions and value based neural network that recommends actions and predicts a value for scenes against the strategic goal.

In general, an autonomous vehicle (AV) includes an AV controller and a decision unit. The decision unit is configured to generate a current driving scene state from environment data and localization data, generate a probability of distribution of actions and an estimated scene value based on the current driving scene state, driving scene state history and a strategic vehicle goal state, select an action from the probability of distribution of actions, determine estimated trajectories of non-AV actors based on the selected action, the current driving scene state, the driving scene state history, and the strategic vehicle goal state, determine estimated trajectory of the AV based on at least the selected action and the estimated scene value, determine a drive action based on maximizing scene value to reach the strategic vehicle goal state, and update the AVcontroller with one of a trajectory or commands to control the AV, where the trajectory or the commands are based on determined drive actions. In an implementation, the decision unit is further configured to generate a virtual scene state based on at least the estimated trajectory of the AV and the estimated trajectories of non-AV actors. In an implementation, each type of scene state includes information about AV and non-AV actors in the scene, and wherein the information includes at least position, velocity, heading angle, distance from center of the road, distance from left and right edges of the road, current road speed limit, and a strategic-level goal for the AV. In an implementation, the decision unit is further configured to generate a probability of distribution of actions and estimated scene values based on at least the virtual scene state. In an implementation, the decision unit is further configured to iteratively perform action selection, trajectory estimation of the non-AV actors, trajectory estimation of the AV, virtual scene state generation and probability of distribution of actions and estimated scene values generation based on at least the virtual scene state until an event horizon. In an implementation, the AV further includes a localization unit configured to generate a contextual understanding of environment from the environment data and determine an AV position with respect to the contextual understanding of the environment. In an implementation, scene state tree exploration from a given scene state to a next scene state are reduced in breadth and depth scope using a combined policy/actions and value based neural network that recommends actions and predict values for scenes against the strategic goal.

In general, a method for behavioral planning in an autonomous vehicle (AV) includes generating a probability of distribution of actions and an estimated scene value based on a current driving scene state, driving scene state history and a strategic vehicle goal state. An action is selected from the probability of distribution of actions, where action selection and scene state tree exploration from a given driving scene state to a next driving scene state are reduced in breadth and depth scope using a combined policy/actions and value based neural network that recommends actions and predicts a value for driving scenes against the strategic goal. A selected action is applied to the current driving scene state to generate a virtual scene state based on at least an estimated trajectory of the AV and estimated trajectories of non-AV actors. Drive actions are determined based on maximizing scene value to reach the strategic vehicle goal state. A controller is updated with one of a trajectory or commands to control the AV, where the trajectory or the commands are based on determined drive actions. In an implementation, the method further includes generating a current driving scene state from environment data and localization data. In an implementation, the method further includes generating a contextual understanding of environment from the environment data and determining an AV position with respect to the contextual understanding of the environment. In an implementation, each type of scene state includes information about AV and non-AV actors in the scene, and wherein the information includes at least position, velocity, heading angle, distance from center of the road, distance from left and right edges of the road, current road speed limit, and a strategic-level goal for the AV. In an implementation, the method further includes generating a probability of distribution of actions and an estimated scene value based on at least the virtual scene state. In an implementation, the method further includes iteratively performing at least the selecting the action, applying a selected action, and generating a probability of distribution of actions and an estimated scene value based on at least the virtual scene state until an event horizon.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for behavioral planning in an autonomous vehicle (AV), the method comprising:
generating a current driving scene state from environment data and localization data;
generating a probability of distribution of actions and an estimated scene value based on the current driving scene state, driving scene state history and a strategic vehicle goal state;
selecting an action from the probability of distribution of actions;
determining estimated trajectories of non-AV actors based on the selected action, the current driving scene state, the driving scene state history, and the strategic vehicle goal state;
determining estimated trajectory of the AV based on at least the selected action and the estimated scene value;
determining a drive action based on maximizing scene value to reach the strategic vehicle goal state; and
updating a controller with one of a trajectory or commands to control the AV, wherein the trajectory or the commands are based on determined drive actions.

2. The method of claim 1, further comprising:
generating a virtual scene state based on at least the estimated trajectory of the AV and the estimated trajectories of non-AV actors.

3. The method of claim 2, wherein each type of scene state includes information about AV and non-AV actors in the scene, and wherein the information includes at least position, velocity, heading angle, distance from center of the road, distance from left and right edges of the road, current road speed limit, and a strategic-level goal for the AV.

4. The method of claim 2, further comprising:
generating a probability of distribution of actions and an estimated scene value based on at least the virtual scene state.

5. The method of claim 4, further comprising:
iteratively performing at least the selecting the action, determining the estimated trajectories of non-AV actors, determining the estimated trajectory of the AV, generating the virtual scene state and generating the probability of distribution of actions and estimated scene value based on at least the virtual scene state until an event horizon.

6. The method of claim 1, further comprising:
generating a contextual understanding of environment from the environment data; and
determining an AV position with respect to the contextual understanding of the environment.

7. The method of claim 1, wherein scene state tree exploration from a given scene state to a next scene state are reduced in breadth and depth scope using a combined policy/actions and value based neural network that recommends actions and predicts a value for scenes against the strategic goal.

8. An autonomous vehicle (AV) comprising:
an AV controller; and
a decision unit configured to:
generate a current driving scene state from environment data and localization data;
generate a probability of distribution of actions and an estimated scene value based on the current driving scene state, driving scene state history and a strategic vehicle goal state;
select an action from the probability of distribution of actions;
determine estimated trajectories of non-AV actors based on the selected action, the current driving scene state, the driving scene state history, and the strategic vehicle goal state;
determine estimated trajectory of the AV based on at least the selected action and the estimated scene value; and
determine a drive action based on maximizing scene value to reach the strategic vehicle goal state; and
update the AVcontroller with one of a trajectory or commands to control the AV, wherein the trajectory or the commands are based on determined drive actions.

9. The AV of claim 8, wherein the decision unit is further configured to:
generate a virtual scene state based on at least the estimated trajectory of the AV and the estimated trajectories of non-AV actors.

10. The AV of claim 9, wherein each type of scene state includes information about AV and non-AV actors in the scene, and wherein the information includes at least position, velocity, heading angle, distance from center of the road, distance from left and right edges of the road, current road speed limit, and a strategic-level goal for the AV.

11. The AV of claim 2, wherein the decision unit is further configured to:
generate a probability of distribution of actions and estimated scene values based on at least the virtual scene state.

12. The AV of claim 11, wherein the decision unit is further configured to:
iteratively perform action selection, trajectory estimation of the non-AV actors, trajectory estimation of the AV, virtual scene state generation and probability of distribution of actions and estimated scene values generation based on at least the virtual scene state until an event horizon.

13. The AV of claim 8, further comprising:
a localization unit configured to:
generate a contextual understanding of environment from the environment data; and
determine an AV position with respect to the contextual understanding of the environment.

14. The AV of claim 8, wherein scene state tree exploration from a given scene state to a next scene state are reduced in breadth and depth scope using a combined policy/actions and value based neural network that recommends actions and predict values for scenes against the strategic goal.

15. A method for behavioral planning in an autonomous vehicle (AV), the method comprising:
generating a probability of distribution of actions and an estimated scene value based on a current driving scene state, driving scene state history and a strategic vehicle goal state;
selecting an action from the probability of distribution of actions, wherein action selection and scene state tree exploration from a given driving scene state to a next driving scene state are reduced in breadth and depth scope using a combined policy/actions and value based neural network that recommends actions and predicts a value for driving scenes against the strategic goal;
applying a selected action to the current driving scene state to generate a virtual scene state based on at least an estimated trajectory of the AV and estimated trajectories of non-AV actors;
determining drive actions based on maximizing scene value to reach the strategic vehicle goal state; and
updating a controller with one of a trajectory or commands to control the AV, wherein the trajectory or the commands are based on determined drive actions.

16. The method of claim 15, further comprising:
generating a current driving scene state from environment data and localization data.

17. The method of claim 16, further comprising:
generating a contextual understanding of environment from the environment data; and
determining an AV position with respect to the contextual understanding of the environment.

18. The method of claim 16, wherein each type of scene state includes information about AV and non-AV actors in the scene, and wherein the information includes at least position, velocity, heading angle, distance from center of the road, distance from left and right edges of the road, current road speed limit, and a strategic-level goal for the AV.

19. The method of claim 16, further comprising:
generating a probability of distribution of actions and an estimated scene value based on at least the virtual scene state.

20. The method of claim 19, further comprising:
iteratively performing at least the selecting the action, applying a selected action, and generating a probability of distribution of actions and an estimated scene value based on at least the virtual scene state until an event horizon.
